(19) United States
(12) Patent Application Publication
(10) Pub. No.: US 2013/0323854 A1
(43) Pub. Date: Dec. 5, 2013

(54) OPTICAL SENSOR FOR DETERMINING QUATERNARY AMMONIUM COMPOUND CONCENTRATION

(71) Applicant: ECOLAB USA INC., St. Paul, MN (US)

(72) Inventors: Paul R. Kraus, Apple Valley, MN (US); Sherri Tischler, Inver Grove Heights, MN (US); Kim R. Smith, Woodbury, MN (US)

(73) Assignee: ECOLAB USA INC., St. Paul, MN (US)

(21) Appl. No.: 13/770,045

(22) Filed: Feb. 19, 2013

Related U.S. Application Data
(60) Provisional application No. 61/655,719, filed on Jun. 5, 2012.

(51) Int. Cl. G01N 21/75

(52) U.S. Cl. CPC G01N 21/75
USPC 436/164; 422/82.05

(57) ABSTRACT

The present disclosure generally relates to a dye that signals when the concentration of a quaternary ammonium compound in antimicrobial solution changes. A sensor is used to monitor changes in the dye wavelength as an indicator of the quat concentration. The use of a sensor leads to improved precision in measuring quat concentration by eliminating or reducing operator bias in reading color or wavelength changes. The dye can be incorporated into a variety of articles including towels, labels, containers, buckets, trays, sinks, spray bottles, liners for containers, buckets, sinks, or spray bottles, indictor wands or strips, and test kits.

### CROSS REFERENCE TO RELATED APPLICATIONS

This application claims the benefit of U.S. Provisional Application Ser. No. 61/655,719, filed Jun. 5, 2012, which application is incorporated herein by reference.

### BACKGROUND

Maintaining adequate levels of antimicrobial concentration is necessary to ensure that an antimicrobial solution is effective at reducing microorganisms. This is important in industries that are sensitive to microorganisms like the food service or healthcare industries where microorganisms can cause food spoilage, illness, or infection. Frequently replacing an antimicrobial solution is one way to maintain the antimicrobial concentration. But, this may result in wasting active antimicrobial solution.

There is a need for improved, precise methods of monitoring antimicrobial concentrations.

### SUMMARY

Surprisingly, it has been discovered that optical sensors can be used to monitor and report the concentration of antimicrobials and in particular quaternary ammonium compounds. Accordingly, the present disclosure generally relates to the use of an optical sensor to measure light intensity as a function of the wavelength of a dye that reacts with a quaternary ammonium compound. This measurement serves as an indicator for the concentration of a quaternary ammonium compound, or quat.

Accordingly, in some aspects, the disclosure relates to a system for determining the concentration of a quaternary ammonium compound where the system includes a dye. The dye has a first wavelength at a first concentration of a quaternary ammonium compound and a second wavelength at a second concentration of a quaternary ammonium compound. The system also includes a sensor capable of measuring the light intensity of the dye as a function of the wavelength of the dye and converting that measurement to a digital output.

In some aspects, the disclosure relates to a method of monitoring the concentration of a quaternary ammonium compound by contacting an antimicrobial solution having a quaternary ammonium compound concentration greater than a certain threshold with a dye. The method includes a dye where the dye has a first wavelength if the concentration of the quaternary ammonium compound is above the threshold and a second wavelength if the concentration of the quaternary ammonium compound is below the threshold. The method further includes measuring the wavelength of a dye with a sensor that measures the light intensity of the dye and converts the light intensity measurement to a digital output that corresponds to the concentration of quaternary ammonium compound. The method further includes using the quaternary ammonium solution for a period of time. The method includes adding quaternary ammonium solution in response to the dye changing from a first wavelength to a second wavelength as the quaternary ammonium compound concentration drops below the threshold.

In some aspects, the disclosure relates to a method of monitoring the concentration of a quaternary ammonium compound in a container by placing a sensor into the container. The sensor measures the color of a dye that is in contact with a quaternary ammonium compound antimicrobial solution in the container. The method includes measuring light intensity as a function of the wavelength of a dye with the sensor. The dye has a first wavelength if the concentration of the quaternary ammonium compound is above 100 ppm and a second wavelength if the concentration of the quaternary ammonium compound is below 100 ppm. The method includes converting the sensor's light intensity measurement to a digital output that corresponds to the concentration of quaternary ammonium compound. The method further includes using the quaternary ammonium solution for a period of time and adding quaternary ammonium solution in response to the dye changing from a first wavelength to a second wavelength if the concentration drops below 100 ppm of the quaternary ammonium compound.

These and other embodiments will be apparent to those skilled in the art and others in view of the following detailed description of some embodiments. It is understood, however, that this summary, and the detailed description illustrate only some examples of the various embodiments, and are not intended to be limiting to the claimed invention.

### BRIEF DESCRIPTION OF THE DRAWINGS

FIG. 1 shows color readings for the RGB channels of a color sensor showing the quat concentration dependent responses.

FIG. 2 shows the combined color readings for the RGB channels of a color sensor showing the quat concentration dependent responses.

### DETAILED DESCRIPTION

The present disclosure generally relates to using an optical sensor that measures light intensity as a function of the wavelength of a dye, which in the presence of quat has a first wavelength if the concentration of the quaternary ammonium compound is above a threshold and a second wavelength if the concentration of the quaternary ammonium compound is below a threshold. Because the wavelength corresponds to the quaternary ammonium compound concentration, the sensor and dye can serve as a real time indicator for quat concentration. An optical sensor measuring the dye signals when the concentration of the quat changes. The dye is preferably pH stable, meaning that the wavelength change of the dye associated with the change in quat concentration is independent of the pH of the quat solution. Put another way, the dye preferably performs the same if the antimicrobial solution is at an acidic, neutral, or basic pH. This is in contrast to pH indicator dyes that are specifically designed to change color as the pH changes. In some embodiments, the dye is reversible in that once it changes from a first wavelength to a second wavelength, it can also change from the second wavelength back to the first wavelength. This is in contrast to indicator dyes, such as those on quaternary ammonium test strips that do not change back to their original color once they have changed color.

In some embodiments, the change may be multicolored or over multiple wavelengths where the dye changes from a first wavelength to a second wavelength as the concentration nears a first threshold (such as a warning threshold), and then changes from the second wavelength to the third wavelength once the concentration reaches a second threshold (such as the point where the solution is no longer an effective antimicrobial solution). In some embodiments, the wavelength change is arbitrary and not linked to the effectiveness of the solution. In such embodiments, the change serves as a reminder to replace the antimicrobial solution before the solution stops being effective. In some embodiments, the change can be triggered by a time lapse and not the quaternary ammonium concentration.

In some embodiments, the “change” in dye wavelength includes a change from a first color to a second color, or from no color to color, or color to no color. A visual color change may be desirable in addition to the output from the sensor. In some embodiments, the “color change” can include words or symbols appearing where words or symbols were not previously there or were a different color. The word could be part of an article or part of the output from the sensor. Alternatively, a container may go from clear or colorless to colored, or white to colored or vice versa (colored to clear/colorless or colored to white) for the “color change.”

In some embodiments, the sensor numerically describes the concentration of quat, such as in parts per million or percentages. In some embodiments, the sensor's output reveals a word which calls for the introduction of additional quat. In some embodiments, the sensor provides a digital output that would reveal a symbol, which would call for the introduction of additional quat. In other embodiments, the sensor provides an alert as an output (visual, audio, vibration etc.), which calls for the introduction of additional quat. The sensor signal would occur when the level of quat drops below a predetermined critical level. The output may include words, phrases, instructions, or graphics for the user to check the concentration of the antimicrobial solution, such as: “CHANGE”, “REPLACE”, “QUAT”, “IT IS TIME TO CHANGE THE SOLUTION”, “NO QUAT” and the like. Alternatively, the digital output can also include a word or phrase disappearing such as: “QUAT”, “ANTIMICROBIAL” and the like.

In some embodiments, the wavelength change occurs in the visible range and shows up as a color change. These embodiments allow a user to identify the color change visually and numerically or digitally. In some embodiments, the “color change” or “wavelength change” may occur outside of the visible range of colors and may be detected by an optical sensor instead of or in addition to visually. Additionally, the “color change” can be such that, even in the visible range, the change in color is too slight to perceive visually, but can nevertheless be quantified by the sensor. In such embodiments where the color change is not perceptible to the eye or occurs outside of the visible range, the optical sensor can be used to measure the change.

Exemplary optical sensors include color (RGB) sensors that measure the color or wavelength of a substrate such as a test strip, coupon, probe, tag, container, article, or the like. One example of a commercially available sensor is the TCS230LM programmable color light-to-frequency converter from Texas Advanced Optoelectronic Systems (Plano, Tex.). Other examples include the CZ-V20 Series or CZ Series RGB sensors from Keyence America, the 59702 RGB sensor from Hamamatsu Japan, the MAX44006 and MAX44008 RGB sensors from Maxim, the D800 or D800E image sensor from Nikon, or the ColorMax-1000 Discrete, ColorMax-1000 Hex, ColorMax-1000 RGB, or ColorMax-1000 Flex sensors from EMX Industries, Inc.

An integrated light-to-frequency converter provides RGB color sensing and is performed by a photodiode grid consisting of 16 groups of 4 elements each. Each group consists of a red sensor, a green sensor, a blue sensor, and a clear sensor with no filter. The sensor can detect the light loss at the interface of a dye due to interaction of the dye with quat. The digital output for each color is a square wave whose frequency is directly proportional to the intensity of the selected color. The color information is input directly to a processor by sequentially selecting each color channel, then counting pulses or timing the period to obtain a value. The use of light-to-frequency eliminates circuitry since transimpedance amplifiers and analog-to-digital converters are no longer needed. Furthermore, the sensor may be located remotely from the processor with no loss of noise immunity.

In some embodiments, an optical sensor can be designed as a handheld pen-sized sensor for measuring quat concentration in buckets, sinks or the like. Such a sensor could be found in a “pen”- or “flashlight”-like article that a user flashes at the article. Another exemplary sensor is a pen that has the dye component integrated into the pen that also contains a light source and the sensor. In some embodiments, the sensor may be integral with a container such that the sensor provides a constant or periodic reading of the quaternary ammonium compound concentration in the container.

The sensor may optionally include a transmitter and receiver such as in a wireless device that would be able to identify a remote solution as being near or below a threshold and send a signal to a location (such as a computer terminal or cloud network) that would alert a user that the solution needs to be adjusted or replaced.

In some embodiments, an optical sensor may be designed as a single-use test surface where it is placed in a solution to read changes in light intensity as a function of wavelength and therefore the quat concentration. In some embodiments, the wavelength changes as the concentration passes a certain threshold. In some embodiments, the threshold is the point where the antimicrobial solution goes from being an effective antimicrobial solution to not being an effective antimicrobial solution. For example, for some applications, the antimicrobial solution preferably includes at least about 100, 150, or 200 ppm of quaternary ammonium compound for the overall solution to be effective. For other applications, the antimicrobial solution preferably includes at least about 600, 800, 1000, or 2000 ppm of quaternary ammonium compound for the overall solution to be effective. Therefore, in some embodiments, the disclosed dye changes wavelength as the concentration drops under 100, 150, 200, 600, 800, 1000, or 2000 ppm quaternary ammonium compound. In some embodiments, the wavelength changes before the quaternary ammonium compound drops under the threshold to signal that the concentration of quaternary ammonium compound is getting close to being low. For example, it may be desirable for the wavelength change to happen at least 100 ppm before the concentration of quaternary ammonium compound drops under the threshold, i.e., 200, 250, 300, 700, 900, 1100, or 2100 ppm if using the above stated thresholds. In some embodiments, it may be desirable for the wavelength change to be gradual as the concentration nears the threshold and complete once the concentration reaches threshold quaternary ammonium compound concentration.

In some embodiments, the dye may be immobilized on a clear (plastic or glass) indicator wand together with an optical sensor. The wand can be configured in such a way that the sensor is located on the “back” or “dry” side of the wand and when the opposing or “wet” side of the wand is inserted into a quaternary ammonium compound or solution, the dye on the wet side would change color and that color change would be measurable by the sensor.

In some embodiments, a sensor may be incorporated directly into a dispenser to verify that adequate sanitizer concentrations were dispensed. If the dispenser includes a sensor, then the sensor could provide feedback to the dispenser such that the dispenser keeps dispensing product until the correct concentration of quat has been dispensed. The dispenser could also be programmed to automatically dispense additional product if the concentration of quat at any time drops below the desired threshold.

In some embodiments, exemplary dyes include dyes that are pH independent and pH stable where the wavelength change is not sensitive to pH swings of at least 0.5 pH units. The dyes exhibit a first color or wavelength when the concentration of quaternary ammonium compound is above a threshold and a second color or wavelength when the concentration of quaternary ammonium compound is below a threshold. Preferred dyes have been found to be purple where the purple is a true purple and not simply a combination of red and blue dyes. Preferred dyes are anionic. The dye may be water soluble or water insoluble. Exemplary dyes include Acid Violet 148, bromothymol blue, and alkali purple. The name of the dye is not indicative of its properties. For example, bromothymol blue is actually purple and not blue. In an embodiment, the dye is not bromothymol blue. One particularly preferred dye includes Acid Violet 148, commercially available from KeyColour, which is purple in the presence of quaternary ammonium compound and blue in the absence or reduced presence of quaternary ammonium compound. This dye changes color in real time and is independent of the pH of the antimicrobial solution.

The dyes may be incorporated into a variety of articles such as towels, labels, containers, buckets, trays, sinks, spray bottles, liners for containers, buckets, sinks, or spray bottles, indictor wands or strips, coupons, and test kits. Regarding the label, the dye can be incorporated into the label itself or into the ink that gets printed onto the label. The dye can also be incorporated into the materials that form the article, such as ink, paper, the plastic, ceramic, metal, or glass that forms a container, strip or coupon, or the material that forms a woven or nonwoven fabric. For example, when synthetic textiles are made, the process starts with resin pellets and is then extruded to make fine filaments. The dye can be incorporated into the resin and then extruded to form the filaments. Thus the dye will be integral with the fiber that goes on to form thread and eventually a woven or nonwoven textile. The dye can also be incorporated into a paint and then painted onto the article. Exemplary plastics include high density polyethylene, low density polyethylene, linear low density polyethylene, ethylene vinyl acetate, ethylene methyl acrylate, ethylene acrylic acid, ethylene methacrylic acid, polypropylene, nylon, PET, PVC (polyvinyl chloride), PVdC, EVOH, polyurethane, Barex, polystyrene, and combinations thereof. The concentration of the dye can be increased or decreased to change at a higher or lower concentration of quaternary ammonium compound. A sub-stoichiometric concentration of dye to quaternary ammonium compound has been found to be sufficient for creating the necessary color change.

If the dye is water insoluble, it is not like to leach out into the quaternary ammonium compound solution over time once it is incorporated into an article. But, if the dye is water soluble, it may be desirable to bind the dye to a substrate to prevent leaching of the dye into solution. In some embodiments, it is desirable to bond the dye to a substrate or matrix in such a way that the dye is bound and prevented from leaching out into solution, but in a way that still allows the bound dye to react with the quat and change wavelength. Exemplary substrates include a white, clear (colorless), or colored paint or lacquer, a polymer or resin for extruding or injection molding plastic articles, a resin, polymer, or natural fiber for forming fabrics.

In some embodiments, it is advantageous for the color change be passive to the observer, meaning that the user or observer does not need to perform a specific activity such as putting a test strip into the solution in order to see the color change. Examples of this include a color changing container that changes color as the quaternary ammonium concentration changes or using a sensor that continuously monitors and reports the concentration.

The present disclosure may be better understood with reference to the following examples. These examples are intended to be representative of specific embodiments of the disclosure and are not intended to be limiting to the scope of the disclosure.

### EXAMPLES

### Example 1

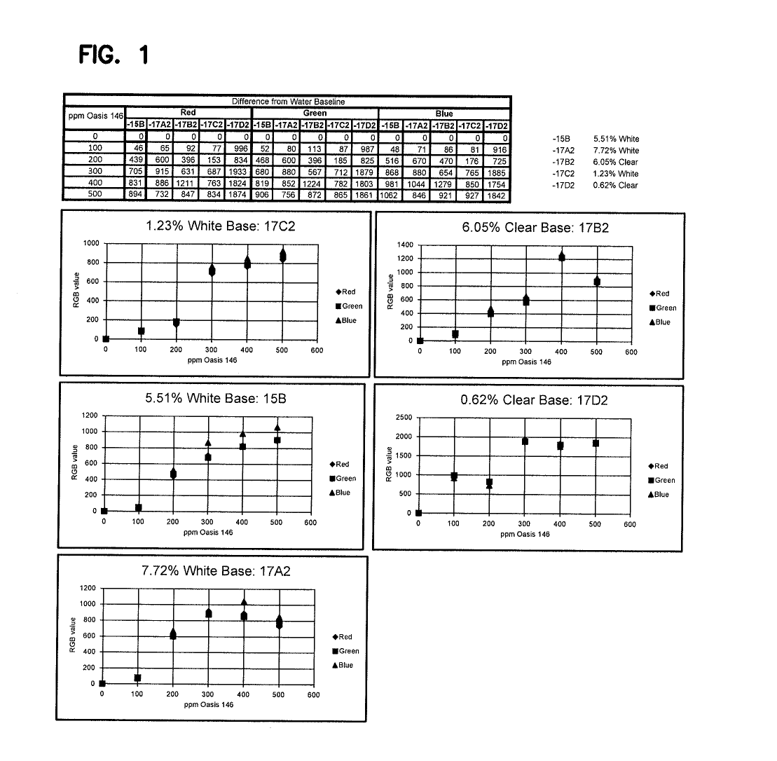

Acid Violet 148 dye (available from Key Colours) was added to both Rust-Oleum 7791 Satin White Enamel and Rust-Oleum 7701 Crystal Clear paints after a quantity of the paint was captured in a bottle by spraying into the bottle. Samples of Satin White contained 1.23, 5.51 and 7.7% w/w Acid Violet 148. Samples of Crystal Clear contained 0.62 and 6.0% w/w Acid Violet 148 in 7701 Crystal Clear. Several drops of quat samples prepared from Oasis 146 (a quaternary ammonium compound antimicrobial composition commercially available from Ecolab Inc.) were placed on the test surface and the color was measured using a TCS230LM programmable color light-to-frequency converter from Texas Advanced Optoelectronic Systems (Plano, Tex.). The color measurements from the RGB channels of the color sensor demonstrate a quat concentration dependent response illustrated in FIG. 1. FIG. 1 shows a quat color test using a 16-bit RGB setting. The individual red, green, and blue values were combined into a single value using the following equation where R₀, G₀, and B₀ are the reference colors and Rₙ, Gₙ, and Bₙ are the sample measurements:

Distance=\sqrt{(Rₙ−R₀)²+(Gₙ−G₀)²+(Bₙ−B₀)²}

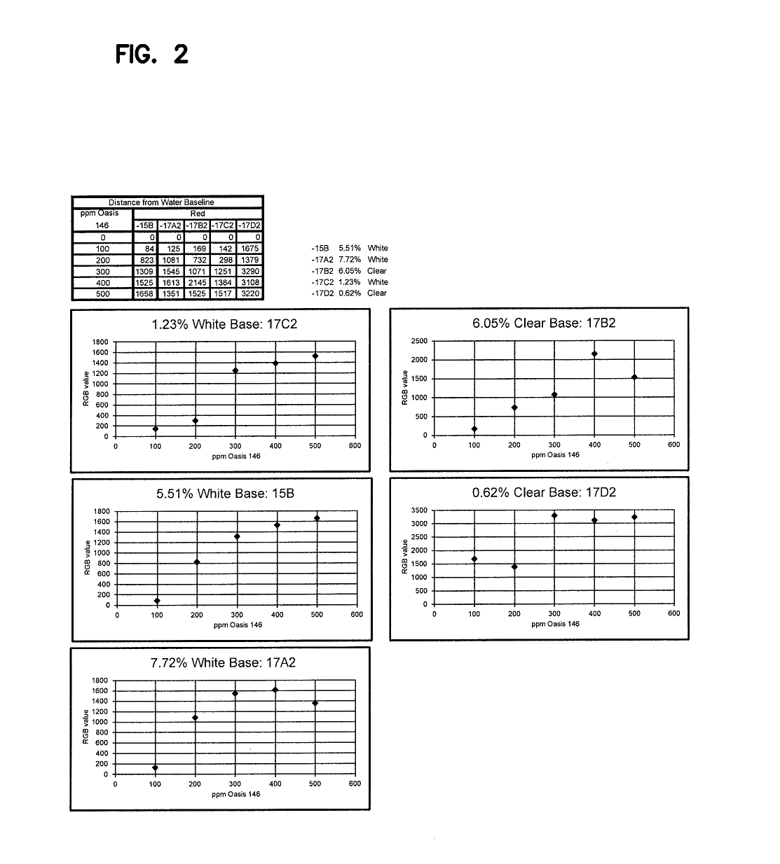

The combined calculations are shown in FIG. 2. As the data in FIGS. 1 and 2 illustrate, the response is also dependent upon the dye concentration in the paint. This suggests that the response can be optimized for the desired quat concentration range to be measured. The response is proportional to the quat concentration. The figures also show the response observed for a clear paint.

The samples with 5.51% dye on white paint provided the best concentration-dependent response between 150 ppm and 400 ppm of the quat. The slope of the curve at this concentration is smooth and very predictable, which suggests that the changes in the color of dye will be predictable as the concentration of quat changes. This is desirable in the disclosed indicator system. It was also observed that the white paint appeared to be a better substrate (more predictable) than the clear paint.

The above specification, examples and data describe the disclosure. Additional embodiments can be made without departing from the spirit and scope of the disclosure and are intended to be within the scope of the following claims.

We claim:

1. A system for determining the concentration of a quaternary ammonium compound comprising:
(a) an article;
(b) a dye located on or integral with the article, wherein the dye has a first wavelength at a first concentration of a quaternary ammonium compound and a second wavelength at a second concentration of a quaternary ammonium compound; and
(c) a sensor having an output related to the quaternary ammonium compound concentration.

2. The system of claim 1, wherein the dye is a first wavelength at a concentration above 100 ppm of the quaternary ammonium compound and a second wavelength at a concentration below 100 ppm of the quaternary ammonium compound.

3. The system of claim 1, wherein the dye is pH stable.

4. The system of claim 1, wherein the article is selected from the group consisting of a dispenser, a bucket, a sink, a spray bottle, an applicator, a strip, a coupon, a label, a cloth, a probe, and a sprayer dip tube.

5. The system of claim 4, wherein the dye is integral with the article and the article is selected from the group consisting of a dispenser, a bucket and a sink

6. The system of claim 5, wherein the sensor is incorporated into the wall of the article.

7. The system of claim 4, wherein the article is a label.

8. The system of claim 7, wherein the label comprises:
(a) a front surface;
(b) a back surface; and
(c) an adhesive layer located on either the front surface or back surface.

9. The system of claim 8, wherein the front and back surface are made of paper or polymer.

10. The system of claim 9, wherein the dye is integral with the paper or polymer.

11. The system of claim 8, wherein the dye is part of text or a graphic on the front surface of the label.

12. The system of claim 1, wherein the sensor is a handheld pen-sized sensor.

13. The system of claim 1, wherein the sensor is configured for single-use.

14. The system of claim 1, wherein the sensor is an integrated light-to-frequency converter.

15. The system of claim 14, wherein the sensor includes an RGB color sensor.

16. The system of claim 14, wherein the light-to-frequency provides digital output in real time.

17. A method of monitoring the concentration of a quaternary ammonium compound comprising:
(a) contacting a quaternary ammonium compound antimicrobial solution having a quaternary ammonium compound concentration greater than 100 ppm with a dye located on or integral with an article, wherein the dye has a first wavelength if the concentration of the quaternary ammonium compound is above 100 ppm and a second wavelength if the concentration of the quaternary ammonium compound is below 100 ppm;
(b) measuring or deriving the wavelength of the dye with a sensor, wherein the sensor provides an output related to the quaternary ammonium compound concentration;
(c) using the quaternary ammonium solution for a period of time; and
(d) adding quaternary ammonium solution in response to the dye changing from a first wavelength to a second wavelength in the presence of less than 100 ppm of the quaternary ammonium compound.

18. The method of claim 17, wherein the article is made from a polymer selected from the group consisting of a high density polyethylene, low density polyethylene, linear low density polyethylene, ethylene vinyl acetate, ethylene methyl acrylate, ethylene acrylic acid, ethylene methacrylic acid, polypropylene, polyethylene terephthalate, polyvinyl chloride, polystyrene, and mixtures thereof.

19. The method of claim 17, wherein the sensor is incorporated into a wall of the article.

20. A method of monitoring the concentration of a quaternary ammonium compound in a container comprising:
(a) inserting a sensor into a container with an integrated dye, wherein the dye has a first wavelength and a second wavelength;
(b) contacting the dye with a quaternary ammonium compound solution;
(c) measuring or deriving the wavelength of the dye using the sensor;
(d) using the quaternary ammonium solution for a period of time; and
(e) adding quaternary ammonium solution in response to the dye changing from a first wavelength to a second wavelength.
